(19) United States
(12) Patent Application Publication
(10) Pub. No.: US 2005/0012573 A1
(43) Pub. Date: Jan. 20, 2005

(54) Method and apparatus for the conversion of rigid coaxial transmission line for broadband use.

(75) Inventor: Brett John Grandchamp, Bangor, ME (US)

Correspondence Address: Brett J. Grandchamp;EXH Inc., 2 Woodland Road, Sudbury, MA, 01776, US

(73) Assignee: EXH INC., Sudbury, MA (US)

(21) Appl. No.: 10/604,423

(22) Filed: Jul. 19, 2003

(51) Int. Cl. H01P 3/06

(52) U.S. Cl. 333/243

(57) ABSTRACT

The invention disclosed herein comprises a method by which rigid coaxial transmission line may be made suitable for broadband applications. Sections of coaxial transmission line of varying lengths are inserted into an existing transmission line run. The lengths and placement of these sections is calculated according to this method.

### CROSS REFERENCE TO RELATED APPLICATIONS

Provisional patent application made Jul. 20, 2002

### BACKGROUND OF INVENTION

This invention relates to rigid coaxial transmission line and, in particular, to a method and apparatus which, when installed in a transmission line run, will prevent the constructive addition of reflections and result in low voltage standing wave (VSWR) characteristics over a substantial band of frequencies.

For high power applications it is conventional to couple power from the amplifier to the antenna through rigid coaxial transmission line. It is conventional to construct this rigid transmission line by connecting together multiple sections of line. The length of these sections is generally dictated by manufacturing requirements and limitations imposed by the environment into which they will be installed. Typically the sections are all of the same length. The electrical performance of such transmission line is degraded at frequencies where the length of each section is a multiple of one half of an electrical wavelength (critical frequency). At these critical frequencies, the reflections caused by the joints at which the line sections are fastened together, add constructively. This causes high VSWR that is undesirable and in many cases intolerable for high power applications. The nominal length of the sections is therefore carefully chosen so that the operating frequencies of the amplifier and the frequencies of degraded performance do not coincide. In some instances however, the amplifier operating frequencies may be required to change after the transmission line has been manufactured. In such cases the prior art technique may not be effective and high VSWR may exist on the transmission line. Conventionally in cases such as this, the entire transmission line is replaced.

An object of the present invention is to provide a method by which the accumulation of reflections, in conventional rigid coaxial transmission lines operating at a critical frequency, is eliminated. This is accomplished by inserting into the existing transmission line, at defined intervals, short sections of similar transmission line of various calculated lengths. Other objects and features will be in part apparent and in part pointed out hereinafter.

### SUMMARY OF INVENTION

An object of the present invention is to provide a method by which the accumulation of reflections, in conventional rigid coaxial transmission lines operating at a critical frequency, is eliminated. This is accomplished by inserting into the existing transmission line, at defined intervals, short sections of similar transmission line of various calculated lengths. The elimination of the accumulation of the reflections and the subsequent high VSWR allows the use of the rigid coaxial transmission line in broadband applications. Other objects and features will be in part apparent and in part pointed out hereinafter.

### DETAILED DESCRIPTION

The present invention comprises N−1 lengths of coaxial transmission line where

N=J/(K-1)

J is the number of same length sections in the transmission line installation that is being modified. K is the compensation group size. K is an integer that may vary from one to five. K=3 is optimum.

Finally the length L of each section is given by
L=Lambda*(A+0.5*B+M/(2*(N−1))−0.25)

Lambda is the electrical wavelength corresponding to the frequency at which the amplifier will operate.

A is an integer chosen to make the length practical for manufacturing.

B is an integer chosen to make the length practical for manufacturing.

A=1 and B=0 is optimum.

M is a range variable that varies from 0 to N−2.

These compensating sections are then inserted into the existing transmission line run at intervals of K same length sections. The compensating line sections much be inserted sequentially starting with the shortest and ending with the longest or starting with the longest and ending with the shortest. The resulting transmission line comprises N groups of K same length sections joined together by N−1 variable length sections.

1. A set of N−1 sections of coaxial transmission line whose lengths are defined by the equation L=Lambda*(A+0.5*B+M/(2*(N−1))−0.25) where L is a nominal section length, Lambda is the wavelength at the design operating frequency of the coaxial transmission line. A is an integer chosen to make the lengths practical for manufacturing. Typically A=1. B is an integer chosen to make the lengths practical for manufacturing. Typically B=0. M is a range variable that varies from zero to N−2. N is an integer determined by the equation N=(J/K)−1 where J is the number of same length sections in an existing transmission line run. K is an integer. Typically K=3.

2. A set of N−1 sections of coaxial transmission line whose lengths are defined by the equation L=Lambda*(A+0.5*B+M/(2*(N−1))−0.25) where L is a nominal section length, Lambda is the wavelength at the design operating frequency of the coaxial transmission line. A is an integer chosen to make the lengths practical for manufacturing. Typically A=1. B is an integer chosen to make the lengths practical for manufacturing. Typically B=0. M is a range variable that varies from zero to N−2. N is an integer determined by the equation N=(J/K)−1 where J is the number of same length sections in an existing transmission line run. K is an integer. Typically K=3.

3. A set of N−1 sections of coaxial transmission line as set forth in claim 2 inserted into an existing transmission line run comprising J sections of the same length in order to prevent the constructive addition of reflections from the joints of the resulting combined transmission line resulting in low VSWR characteristics at the design operating frequency.

4. A set of N−1 sections of coaxial transmission line as set forth in claim 2 inserted into an existing transmission line run comprising J same length sections such that K same length sections are installed between each of the N−1 variable length sections. Typically K=3.

5. A coaxial transmission line run as set forth in claim 4 having low VSWR characteristics over a wide band of frequencies centered at the design operating frequency.
